(19) United States
(12) Patent Application Publication
(10) Pub. No.: US 2002/0063163 A1
(43) Pub. Date: May 30, 2002

(54) Microminiature card

(75) Inventor: Takayuki Shinohara, Tokyo (JP)

Correspondence Address: MCDERMOTT, WILL & EMERY, 600 13th Street, N.W., WASHINGTON, DC, 20005-3096, US

(73) Assignee: Mitsubishi Denki Kabushiki Kaisha

(21) Appl. No.: 09/836,178

(22) Filed: Apr. 18, 2001

(30) Foreign Application Priority Data
Nov. 30, 2000 (JP) P2000-365241

(51) Int. Cl. G06K 19/06

(52) U.S. Cl. 235/492

(57) ABSTRACT

The present invention provides a microminiature card capable of being assembled by means of a conventional surface mounting technique using an IC packaged by means of a conventional technique such as a thin film small outline package (TSOP). The present invention provides a microminiature card comprises a frame and a packaged integrated circuit embedded in the frame. A part of the packaged integrated circuit is exposed to the external of the card to form a part of an outer surface of the card.

### BACKGROUND OF THE INVENTION

1. Field of the Invention

The present invention relates to a microminiature card used as a storage medium of a digital information electric home appliance such as a portable information terminal or a portable telephone.

2. Description of the Related Art

At present, a microminiature card on which an integrated circuit (hereinafter referred to as IC) is mounted is spreading as the storage medium of a digital information electric home appliance such as a digital camera. Microminiature cards involve, for example, a multimedia card (MMC) having a thickness of 1.4 mm, an SD card (Secure Digital memory card) having a thickness of 2.1 mm and a memory stick (MS) having a thickness of 2.8 mm.

A microminiature card is thinner than a PC card having a thickness of 3.3/5 mm used already widely. Therefore, it becomes difficult to utilize a conventional IC manufacturing technique which has been ordinarily used to manufacture a PC card. Conventional IC's involve, for example, a thin small outline package (TSOP) IC having a thickness of 1.0 mm. For that reason, it is required to adopt a special mounting technique such as a chip on board (COB) technique. This, in turn, causes other problems including mounting density, capital investment for a new processing step and the like.

### SUMMARY OF THE INVENTION

It is an object of the present invention to provide a microminiature card which can be assembled by means of a conventional surface mounting technique using an IC packaged by a conventional technique such as a thin small outline package (TSOP).

A microminiature card according to the present invention comprises a frame and a packaged integrated circuit embedded in the frame. The part of the packaged integrated circuit is exposed to the external of the card to form a part of an outer surface of the card.

Two of the packaged integrated circuits may be embedded in the frame. Surfaces of the two of the packaged integrated circuits constitute a part of two surfaces of the outer surface of the card.

The microminiature card further comprises a protective sheet bonded to cover the part of the packaged integrated circuit and forming the part of the outer surface of the microminiature card.

The protective sheet may be bonded so as to cover a wider range of the part of the outer surface of the card than the part of the packaged integrated circuit.

The microminiature card may be a multimedia card or an secure digital memory card.

According to the present invention, it is possible to secure the thickness of the thin portion of the frame and to facilitate the formation of the card by utilizing conventional IC's.

### BRIEF DESCRIPTION OF THE DRAWINGS

First to third embodiments of the present invention will now be described hereinafter by way of example and with reference to the appended drawings, in which:

FIG. 1 is a cross-sectional view of the first microminiature card in the first embodiment according to the present invention;

FIG. 2 shows the arrangement of the constituent elements of the first miniature card at the time of assembling the microminiature card;

FIG. 3 is a cross-sectional view of the second microminiature card in the first embodiment according to the present invention;

FIG. 4 shows the arrangement of the constituent elements of the second miniature card at the time of assembling the microminiature card;

FIG. 5 is a cross-sectional view of a microminiature card in the second embodiment according to the present invention;

FIG. 6 is a cross-sectional view of the first microminiature card in the third embodiment according to the present invention;

FIG. 7 is a cross-sectional view of the second microminiature card in the third embodiment according to the present invention; and

FIG. 8 shows a microminiature card having an IC exposed to outside and coated with a cover.

### DETAILED DESCRIPTION OF THE PREFERRED EMBODIMENTS

Referring now to the drawings, wherein like reference characters designate like or corresponding parts throughout the several views.

(First Embodiment)

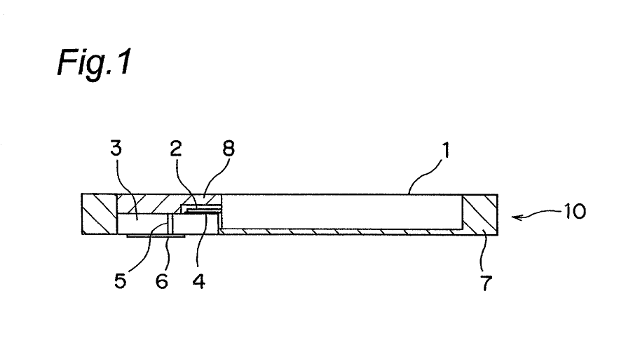

FIG. 1 shows a cross-sectional view of a first microminiature card 10 in a first embodiment of the invention. The microminiature card 10 is, for example, a multimedia card. The microminiature card 10 is installed to a host apparatus (not shown) by a user. The microminiature card 10 is capable of storing and reading digital data such as digital image data and digital picture data.

The microminiature card 10 has an IC 1, IC leads 2, a printed wiring board 3, IC connection pads 4, through holes 5, external connection pads 6, a frame 7 and a sub-frame 8. The microminiature card 10 in the first embodiment is characterized in that a part of the surface of the microminiature card 10 is constituted by the surface of the IC 1 mounted on the microminiature card 10, i.e., the IC 1 appears on the surface of the microminiature card 10 and forms a part of the outer surface thereof.

More specifically, the IC 1 is embedded in the frame so that a part of the surface of the IC 1 is exposed to the external of the card to form a part of an outer surface of the card 10 and that of the frame 7 are almost flush with each other. By thus constituting the microminiature card 10, it is possible to secure the thickness of the thin portion of the frame 7 and to facilitate the formation of the card 10 by utilizing conventional IC's. Since a restriction to the thickness of the printed wiring board 3 is relaxed, it becomes unnecessary to employ an expensive very thin board. The other advantages obtained in this embodiment will be described later.

Now, the respective constituent elements of the microminiature card 10 will be described. The IC 1 is mounted on the microminiature card 10. In this embodiment, the microminiature card 10 is constituted by one packaged IC 1. The IC 1 has, therefore, a flash memory function for storing data and an MMC controller function. These functions can be integrated on one chip using a conventional technique. Alternatively, using a multi-chip package (MCP) technique for mounting a plurality of semiconductor bare chips on a single lead frame, the IC may be packaged to thereby realize mass storage. Since these techniques are well-known, they will not be described herein. In this embodiment, a conventional thin small outline package (TSOP) having a thickness of 1.0 mm is employed as the package of the IC 1.

Next, the IC leads 2 are provided at the IC 1. The IC leads 2 allow the transmission/reception of signals between the IC 1 and the printed wiring board 3. Namely, each of the IC leads 2 connect the IC 1 to the printed wiring board 3. The printed wiring board 3 has a predetermined wiring pattern and IC chip connection pads 4. Each of the IC chip connection pads 4 is connected to each of the IC leads 2 by means of a conventional soldering technique. By thus connecting the pads 4 to the IC leads 2, the IC 1 is electrically connected to the printed wiring board 3. Each of the through holes 5 is a conductor electrically connecting the printed wiring board 3 to each of the external connection pads 6. The frame 7 is a resin-molded frame mainly constituting the outline of the microminiature card 10. The sub-frame 8 is an auxiliary frame for fixing the printed wiring board 3.

Procedures for assembling the microminiature card 10 (FIG. 1) will be described with reference to FIG. 2 so as to describe the structure of the microminiature card 10 (FIG. 1) more clearly. FIG. 2 shows the arrangement of the constituent elements of the microminiature card 10 at the time of assembling the card 10. First, as already stated above, the IC leads 2 of the IC 1 and the IC connection pads 4 (not shown) of the printed wiring board 3 are connected to each other by means of a conventional soldering technique. Since the conventional soldering technique is available, there is no need to provide a complicated connection step and an equipment for the step. Then, the IC 1 and the printed wiring board 3 are stored in the frame 7 and the sub-frame 8 is arranged on the printed wiring board 3.

The IC 1 and the frame 7 are arranged so that the surface of the IC 1 and that of the frame 7 are almost flush with each other. As a result, the IC 1 appears on the surface of the microminiature card 10 and constitutes the outer surface of the card 10. At this time, the frame 7 is bonded to the side portions except for those of the IC lead 2, the lower surface of the IC 1 and the side portions of the printed wiring board 3 by adhesive. The sub-frame 8 is also bonded to the inner surface of the frame 7. In this way, as already described above, the upper surface of the package of the IC 1 mounted on a part of the upper surface of the microminiature card 10 (FIG. 1) is exposed and the upper surface of the IC 1 constitutes the outer surface of the microminiature card 10.

As for the IC leads 2 shown in FIG. 1, if flat IC leads 2 which are not bent are used as the IC leads 2, it is possible to secure the thickness of the printed wiring board 3 by as much as the degree to which the leads 2 are not bent. In this example, the printed wiring board 3 having a thickness of about 0.5 mm can be used. As a result, it becomes unnecessary to employ an expensive very thin board having a thickness of 0.3 mm or less as the printed wiring board 3, thereby making cost reduction possible. It is noted that the IC leads 2 can be soldered to the IC connection pads 4 by means of a conventional technique whether the IC leads are bent or not.

If the microminiature card 10 (FIG. 1) is a multimedia card, a serial interface is used to connect the host apparatus (not shown) to the card 10 and the external connection pad 6 (FIG. 1) may have as few terminals as seven. Therefore, it suffices that the IC leads 2 of the IC 1 are provided as few pins as seven. It also suffices that the IC 1 has IC leads only on one side of the package.

Referring back to FIG. 1, the structure of the microminiature card 10 constituted as stated above will be described from the viewpoint of thickness. The multimedia card exemplified herein has a thickness of 1.4 mm. As already described above, the package of the IC 1 used for the microminiature card 10 has a thickness of 1.0 mm. If the thickness of the adhesive used to bond the IC 1 to the frame 7 is 0.1 mm, it is possible to secure 0.3 mm as the thickness of the thin portion of the resin-molded frame.

By comparison, a case where the IC package is contained in the microminiature card and cannot be recognized from outside will be considered. If the IC package having a thickness of 1.0 mm is used, a thickness of 0.1 mm is required for each of the upper and lower portion of the adhesive. If so, a thickness of as small as 0.1 mm can be provided for each of the upper and lower portion of the thin portion of the frame, making resin molding quite difficult.

Considering this fact, the microminiature card 10 is constituted so that the IC 1 appears on the outer surface of the microminiature card 10 to thereby make the upper surface of the IC 1 and that of the frame 7 flush with each other. As a result, it is possible to utilize a frame which can be easily molded with a resin. In addition, it becomes unnecessary to mold the frame of the microminiature card so as to cover the IC package, thereby facilitating the molding of the frame and process yield.

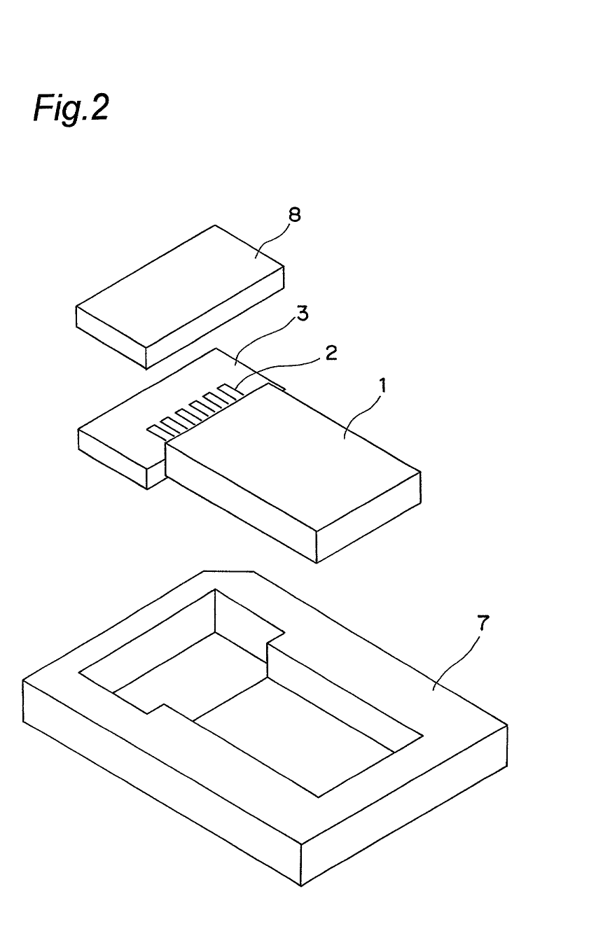

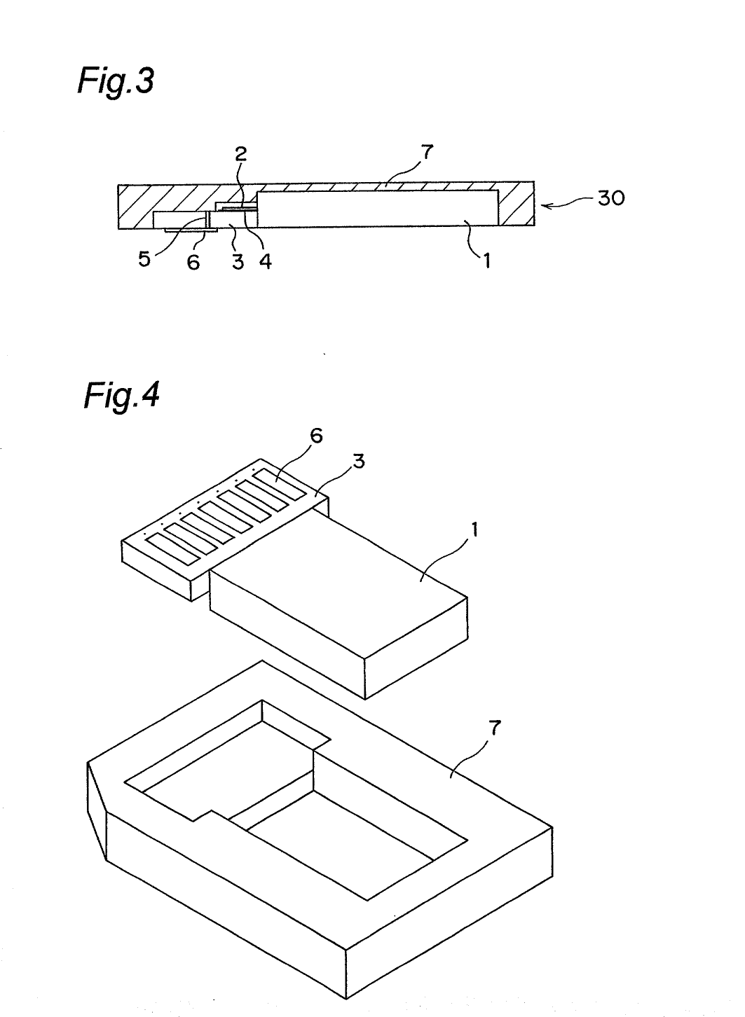

Next, another example of the microminiature card in this embodiment will be described with reference to FIG. 3. FIG. 3 shows a cross-sectional view of the second microminiature card 30 in the first embodiment. The second microminiature card 30 is characterized in that a printed wiring board 3, external connection pads 6 and an IC 1 are provided on the microminiature card 30 to be flush with one another and form a part of the outer surface of the microminiature card 30. In the above-stated example which has been describe with reference to FIG. 1, the IC 1 (FIG. 1) appears on the opposite side to that of the printed wiring board 3 and the external connection pads 6. In case of the microminiature card 30 shown in FIG. 3, the IC 1, the printed wiring board 3 and the external connection pads 6 appear on the same plane.

FIG. 4 shows the arrangement of the constituent elements of the microminiature card 30 (FIG. 3) at the time of assembly of the card 30. The IC 1 and the printed wiring board 3 are electrically connected to each other through IC leads 2 (not shown) and an IC connection pads 4 (not shown) by means of a conventional soldering technique. Thereafter, the IC 1 and the printed wiring board 3 in FIG. 4 are contained in a frame and bonded by adhesive. As is obvious from FIG. 4, a sub-frame 8 (FIG. 2) is unnecessary to manufacture the microminiature card 30 (FIG. 3). It is, therefore, possible to eliminate manufacturing cost for the sub-frame 8 and a manufacturing step of assembling the sub-frame 8 into the card 30.

Needless to say, the microminiature card 30 can provide the same advantages as those of the microminiature card 10 (FIG. 1) described above. Namely, the microminiature card 30 can provide advantages that the conventional soldering technique is available and that the frame 7 can be easily formed. It is noted that in the case of the microminiature card 30, it is necessary to make the printed wiring board 3 thinner than the printed wiring board 3 of the microminiature card 10 (FIG. 1). Nevertheless, the thickness is about 0.4 mm and it is not, therefore, necessary to use a very thin board having a thickness of 0.3 mm or less, thereby making it possible to realize cost reduction.

In this embodiment, description has been given to a case where the microminiature card is, for example, a multimedia card. The present invention should not be limited to such existing cards. For example, the both surfaces of the package of the IC 1 of the microminiature card 10 or 30 may be exposed and form the both sides of the outer surface of the microminiature card. Alternatively, while it is illustrated in the drawings that the entire surface of the package of the IC 1 is exposed, a part of the surface may be exposed according to the shape or the like of the package.

(Second Embodiment)

In the microminiature card of the first embodiment, a very thin board is not used for the printed wiring board 3. As for a microminiature card in a second embodiment, description will be given to a case where a very thin board is provided as a printed wiring board 3 and also a part of the surface of the card is constituted by the surface of an IC mounted on the microminiature card, which is the same feature as that of the first embodiment. In this embodiment as in the case of the first embodiment, the microminiature card is, for example, a multimedia card.

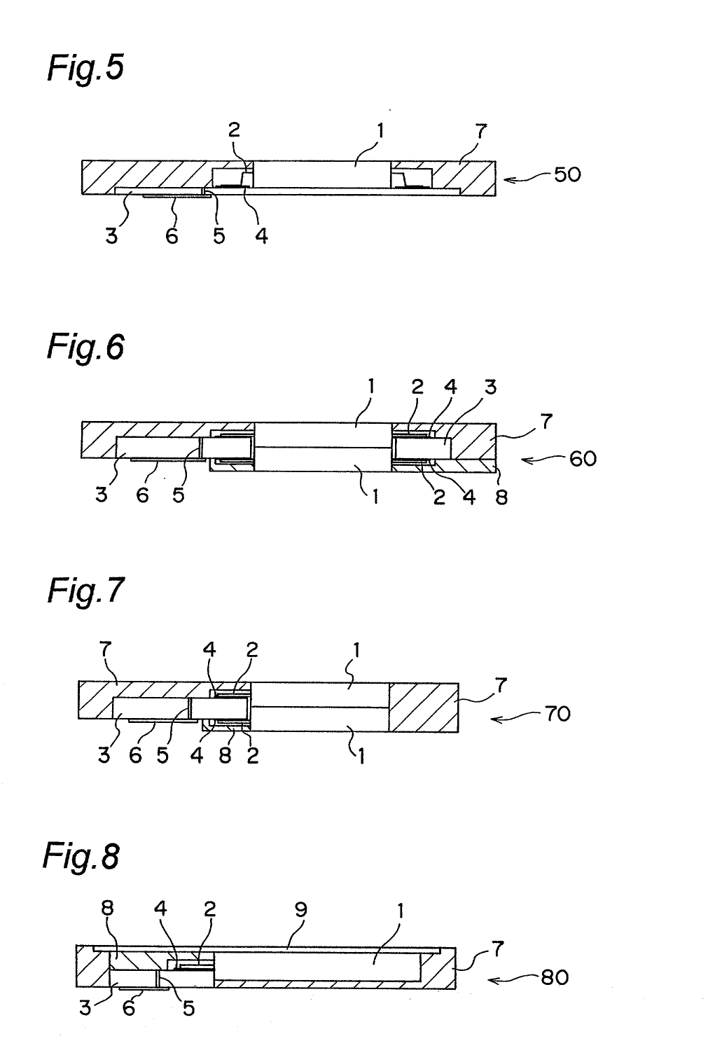

FIG. 5 shows a cross-sectional view of a microminiature card 50 in the second embodiment. As can be seen from FIG. 5, a very thin printed wiring board 3 (having a thickness of 0.2 to 0.3 mm) covers most of the lower surface of the microminiature card 50 and, at the same time, an IC 1 is exposed to the upper surface of the card 50. In addition, since the very thin printed wiring board 3 covers most of the lower surface of the microminiature card 50, it is not necessary to provide a portion corresponding to the thin portion, having a thickness of 0.3 mm or less, of the microminiature card 10 (FIG. 1). This makes it possible to manufacture a frame 7 by a simple step such as punching and to thereby further simplify a resin molding step. The package body portion of the IC 1 is opened in the frame 7.

As the package of the IC 1, a conventional thin small outline package (TSOP) is used. Further, a conventional soldering technique is available to connect IC leads 2 to IC connection pads 4. This embodiment can obtain the advantages described in the first embodiment.

(Third Embodiment)

In a third embodiment of the invention, a microminiature card has two IC's which are exposed to the both sides of the card and constitute the outer surfaces of the card, respectively.

FIG. 6 shows a cross-sectional view of a first microminiature card 60 in the third embodiment. The microminiature card 60 has two IC's 1 each packaged by a thin small outline package (TSOP) while IC leads 2 are unbent. The two IC's 1 are stacked and the surfaces on the opposite sides to those of the surfaces of the IC's adjacent to each other constitute parts of the surfaces of the microminiature card 60, respectively. The surfaces of the IC's exposed to the outside are arranged to be almost flush with the surfaces of a frame 7 or a sub-frame 8. The respective IC leads 2 are also provided to put a printed wiring board 3 therebetween and electrically connected to the IC connection pads 4 of printed wiring boards 3, respectively by means of a conventional soldering technique. As the printed wiring board 3, a board having a thickness of about 0.5 mm is used. The sub-frame 8 is bonded to the frame 7, IC leads 2 and the printed wiring board 3.

Openings for arranging the package body portions of the two ICs 1 are provided in the frame 7 and the sub-frame 8. As a result, the two IC's are provided to penetrate the microminiature card 60 and constitute parts of the surfaces of the microminiature card 60, respectively. In case of the frame 7 in this embodiment as in the case of the second embodiment, it is not necessary to provide a portion corresponding to the thin portion of the card as seen in the first embodiment. This, therefore, makes it possible to manufacture the frame 7 by a simple step such as punching and to make a resin molding step simpler. The microminiature card 60 is, for example, an SD card (having a thickness of 2.1 mm) thicker than a multimedia card.

In the above description, the IC leads 2 of the two IC's 1 are not bent. However, it is possible to bend only the IC lead 2 of the lower IC 1. If so, by thinning the printed wiring board 3 according to the bending of the IC leads 2, it is possible to adjust the position of the external connection pads 6 in the thickness direction of the microminiature card 60 without changing the thickness of the portion of the microminiature card 60 on which the IC 1 is arranged.

As stated above, since the two IC's are exposed to the both sides of the microminiature card 60 and the two IC's 1 constitute the outer surfaces of the microminiature card, respectively, it is not necessary to utilize a thin printed wiring board 3. For example, it is not necessary to utilize an expensive, very thin board having a thickness of 0.3 mm or less. It is, therefore, possible to suppress the increase of manufacturing cost. Besides, since the conventional soldering technique is available, the advantages described in the first embodiment can be obtained.

FIG. 7 shows a cross-sectional view of the second microminiature card 70 in the third embodiment. The microminiature card 70 differs from the microminiature card 60 in that the IC leads 2 of two IC's 1 are directed only to one sides of the IC's and that a sub-frame 8 only covers the IC leads 2 of the lower IC 1. The remaining constitution is the same as that of the microminiature card 60. By thus constituting the microminiature card 70, it is possible to not only obtain the above-stated advantages but also reduce the area of a printed wiring board 3 to thereby manufacture the microminiature card 70 at lower cost.

Various examples of the microminiature cards have been described so far. In any example, it is seen that the IC appears on the surface of the microminiature card and constitutes the outer surface of the microminiature card. Here, since the IC is exposed to the surface of the microminiature card, there is a possibility that an impact is directly applied to the IC.

To protect the IC from the impact or the like, the strength of the microminiature card may be intensified and a cover may be put on the surface of the microminiature card to which the package of the IC is exposed. The cover is sufficiently thin compared with the microminiature card and is, for example, an adhesive-added protective sheet having a thickness of 0.1 mm or less. FIG. 8 shows a microminiature card 80 wherein an IC 1 exposed to the outside laid with a cover 9. The cover 9 lays not only the IC 1 but also most of the upper surface of the card 80. Namely, the cover 9 can conceal gaps between the IC 1 and a frame and, therefore, prevent dust or the like from entering the gaps and adversely affecting the delicate card. Further, since the discontinuous portion between the surface of the IC 1 and that of the frame 7 is weak at bending, these surfaces are laid with an integral protective sheet, thereby making it possible to intensify the strength of the microminiature card.

The microminiature card 80 shown in FIG. 8 is, for example, the microminiature card 10 (FIG. 1) which has been described as a multimedia card and to which the a cover 9 is added. However, the card 80 may be selected from among the microminiature card 30 (FIG. 3), the microminiature card 50 (FIG. 5), the microminiature card 60 (FIG. 6) and the microminiature card 70 (FIG. 7). As a result, it is possible to not only obtain the advantages described in relation to the respective microminiature cards but also to intensify the strength of the IC and to improve the outline of the portion to which the IC is exposed. In FIG. 8, it appears that the frame 7 is processed to have a recess corresponding to the thickness of the cover 9. However, since the cover 9 is thin enough, such processing may not necessarily be carried out.

What is claimed is:

1. A microminiature card comprising:
a frame; and
a packaged integrated circuit embedded in the frame,
wherein a part of the packaged integrated circuit exposed to the external of the card to form a part of an outer surface of the card.

2. The microminiature card according to claim 1, wherein two of the packaged integrated circuits are embedded in the frame, surfaces of which constitute a part of two surfaces of the outer surface of the card.

3. The microminiature card according to claim 1, further comprising a protective sheet bonded to cover the part of the packaged integrated circuit and forming the part of the outer surface of the microminiature card.

4. The microminiature card according to claim 3, wherein the protective sheet is bonded so as to cover a wider range of the part of the outer surface of the card than the part of the packaged integrated circuit.

5. The microminiature card according to claim 1, wherein the microminiature card is a multimedia card.

6. The microminiature card according to claim 1, wherein the microminiature card is a secure digital memory card.
